(19) United States
(12) Patent Application Publication
(10) Pub. No.: US 2015/0282489 A1
(43) Pub. Date: Oct. 8, 2015

(54) SYNERGISTIC FUNGICIDAL COMPOSITIONS CONTAINING LACTOPEROXIDASE SYSTEM

(71) Applicant: DSM IP ASSETS B.V., Heerlen (NL)

(72) Inventors: Jacobus Stark, Echt (NL); Willem Jacobus Ravensberg, Berkel En Rodenrijs (NL); Franciscus Johannes Weber, Berkel En Rodenrus (NL)

(21) Appl. No.: 14/443,517

(22) PCT Filed: Nov. 27, 2013
(86) PCT No.: PCT/EP2013/074843

§ 371 Date: May 18, 2015

(30) Foreign Application Priority Data
Nov. 30, 2012 (EP) 12194943.2

(51) Int. Cl. A01N 63/02; A01N 59/24; A23L 3/3571; A01N 59/00; A23L 3/3463; A23L 3/358; A01N 43/90; A01N 59/12

(52) U.S. Cl. CPC A01N 63/02; A01N 43/90; A01N 59/24; A01N 59/12; A01N 59/00; A23L 3/34635; A23L 3/358; A23L 3/3571; C12Y 111/01007; A23V 2002/00

(57) ABSTRACT

The invention relates to synergistic fungicidal composition containing: a) a polyene fungicide (preferably natamycin) and b) a lactoperoxidase system. The invention further relates to a kit and to products containing said composition and to a method for protecting food products, feed products, pharmaceutical products, cosmetic products and agricultural products with said composition.

### FIELD OF THE INVENTION

The present invention discloses new antimicrobial compositions to control plant diseases and to prevent microbial spoilage of crops.

### BACKGROUND OF THE INVENTION

It is estimated that about 25% of the world crop production is lost due to microbial diseases, of which diseases by fungi is by far the most important cause. Not only from an economical point of view, but also from a humane point of view it is of great importance to prevent spoilage of food products. After all, in many parts of the world people suffer from hunger.

Success in combating plant diseases and in reducing the damage they cause to yields and quality depends greatly on the timely application of fungicides. The prolonged and frequent use of many fungicides such as e.g. benzamidazoles has contributed to reduce their effectiveness thanks to the development of phenomena of resistance. Resistance to many fungicides has been observed on several crops and diseases now (see Brent et al., 2007).

For many decades, the polyene macrolide antimycotic natamycin has been used to prevent fungal growth on food products such as cheeses and sausages. This natural preservative, which is produced by fermentation using Streptomyces natalensis, is widely used throughout the world as a food preservative and has a long history of safe use in the food industry. It is very effective against all known food spoilage fungi. Although natamycin has been applied for many years in e.g. the cheese industry, up to now development of resistant fungal species has never been observed.

Consequently, it can be concluded that there is a severe need for more effective antimicrobial compositions, e.g. antifungal compositions, for the treatment of fungal growth in and on plants and crops.

### DESCRIPTION OF THE INVENTION

The present invention solves the problem by providing a new synergistic antimicrobial, e.g. antifungal, composition comprising a polyene antifungal compound and a lactoperoxidase system. As used herein, the term “synergistic” means that the combined effect of the antifungal components when used in combination is greater than their additive effects when used individually.

In general, synergy can be calculated as follows: the antifungal activity (in %) of the individual active ingredients can be determined by calculating the reduction in mould growth observed on products treated with the active ingredients in comparison to the mould growth on products treated with a control composition. The expected antifungal activity (E in %) of the combined antifungal composition comprising both active ingredients can be calculated according to the Colby equation (Colby, 1967):

E=X+Y−[(X·Y)/100], wherein X and Y are the observed antifungal activities (in %) of the individual active ingredients X and Y, respectively. If the observed antifungal activity (0 in %) of the combination exceeds the expected antifungal activity (E in %) of the combination and the synergy factor O/E is thus >1.0, the combined application of the active ingredients leads to a synergistic antifungal effect.

The lactoperoxidase system may be in powder form or may be in liquid form. In an embodiment the lactoperoxidase system comprises several components. Suitable lactoperoxidase systems in the light of the present invention can be found in WO 99/022597, WO 91/11105 and WO 97/26908, which are incorporated by reference.

Firstly, the system comprises a lactoperoxidase (LP; EC 1.11.1.7). In an embodiment lactoperoxidase is present in an amount ranging from 0.1-10,000 mg/l, preferably 10-100 mg/l. Lactoperoxidase is an enzyme that is naturally present in milk. The lactoperoxidase in the system can be a milk-derived lactoperoxidase. The lactoperoxidase may for example be of bovine, buffalo, goat, sheep, or camel origin. Methods for isolating lactoperoxidase from milk are known. Alternatively, the lactoperoxidase can be made through recombinant biotechnological methods e.g. by producing the enzyme in a host cell such as a yeast or bacterium.

Secondly, the system may comprise a halide selected from the group consisting of iodide (I⁻) or bromide (Br⁻) or a salt thereof such as e.g. potassium iodide, sodium iodide, potassium bromide, sodium bromide or a combination thereof. In an embodiment the halide is present in an amount ranging from 0.1-10,000 mg/l, preferably 25-200 mg/l.

In addition, the system may comprise thiocyanate (SCN⁻). In an embodiment thiocyanate is present in an amount ranging from 0.1-10,000 mg/l, preferably 5-50 mg/l. Thiocyanate can be present in the form of a salt such as e.g. sodium thiocyanate, potassium thiocyanate, ammonium thiocyanate, copper thiocyanate, iron thiocyanate or a combination thereof. In a preferred embodiment the system comprises both a halide as described above and a thiocyanate as described above.

Thirdly, the system comprises hydrogen peroxide. In an embodiment hydrogen peroxide is present in an amount ranging from 0.1-10,000 mg/l, preferably 1-500 mg/l. Hydrogen peroxide may be present as such (e.g. stabilized hydrogen peroxide). Alternatively, a hydrogen peroxide donor system may be present. Suitable hydrogen peroxide donor systems include, but are not limited to, alkali percarbonate (e.g. 2Na₂CO₃3H₂O₂); earth alkali peroxides (e.g. magnesium peroxide) and other solid peroxides (e.g. carbamide peroxide); systems wherein hydrogen peroxide is produced by oxidation of ascorbic acid; systems wherein hydrogen peroxide is produced by oxidation of glucose by glucose oxidase (E.C. 1.1.3.4); systems wherein hydrogen peroxide is produced by oxidation of hypoxanthine by xanthine oxidase; systems wherein hydrogen peroxide is produced by oxidation of reduced pyridine nucleotides by peroxidase action; or any combination of the previous hydrogen peroxide donor systems.

In an embodiment the lactoperoxidase system used in the present invention comprises glucose, glucose oxidase and percarbonate (e.g. sodium percarbonate) as a hydrogen peroxide donor system. In an embodiment glucose is present in an amount ranging from 0.1-10,000 g/l, preferably 1-10 g/l. In an embodiment glucose oxidase is present in an amount ranging from 0.1-10,000 IU/l, preferably 50-1000 IU/l. In an embodiment percarbonate is present in an amount ranging from 0.1-10,000 mg/l, preferably 1-500 mg/l.

In an embodiment the lactoperoxidase systems used in the present invention may also contain two or more different lactoperoxidases, thiocyanates, halides, hydrogen peroxide sources or any combination thereof. Examples of commercial lactoperoxidase systems are products with the names Enzicur (Koppert B. V., The Netherlands). Said commercial products can be incorporated in the present invention.

Before use, a composition according to the invention may be diluted. Dilution may be done with aqueous formulations. The formulations used for diluting may additionally comprise a small amount of oil, for example between 0.01 and 2% (v/v) of oil. When the formulations comprise an oil, the presence of an emulsifier for emulsifying the oil in the aqueous solution to form an oil-in-water emulsion is preferred. The oil is selected from the group consisting of mineral oils, vegetable oils, animal oils and a mixture thereof. Vegetable oils such as rape-seed oils are preferred.

The aqueous formulations used for diluting may also comprise a small amount of a spreading agent, for example between 0.01 and 0.2% (v/v) of a spreading agent. The spreading agent, oil and/or emulsifier may be present in one dilution formulation, but may also be present in separate formulations that are mixed together before or during dilution of a composition according to the invention.

In an embodiment the polyene antifungal compound is selected from the group consisting of natamycin, nystatin, amphotericin B, trienin, etruscomycin, filipin, chainin, dermostatin, lymphosarcin, candicidin, aureofungin A, aureofungin B, hamycin A, hamycin B and lucensomycin. In a preferred embodiment the polyene antifungal compound is natamycin. In an embodiment the compositions may also contain two or more different polyene antifungal compounds. It is to be understood that derivatives of polyene antifungal compounds including, but not limited to, salts or solvates of polyene antifungal compounds or modified forms of polyene antifungal compounds may also be applied in the compositions of the invention. Examples of commercial products containing natamycin are the products with the brand name Delvocid®. Such products are produced by DSM Food Specialties (The Netherlands) and may be solids containing e.g. 50% (w/w) natamycin or liquids comprising between e.g. 2-50% (w/v) natamycin. Said commercial products can be incorporated in the compositions of the invention.

The composition of the present invention generally comprises from about 0.005 g/l to about 100 g/l and preferably from about 0.01 g/l to about 50 g/l of a polyene antifungal compound. Preferably, the amount is from 0.01 g/l to 3 g/l.

In an embodiment the composition of the present invention further comprises at least one additional compound selected from the group consisting of a sticking agent, a carrier, a colouring agent, a protective colloid, an adhesive, a herbicide, a fertilizer, a thickening agent, a sequestering agent, a thixotropic agent, a surfactant, a further antimicrobial compound, a detergent, a preservative, a spreading agent, a filler, a spray oil, a flow additive, a mineral substance, a solvent, a dispersant, an emulsifier, a wetting agent, a stabiliser, an antifoaming agent, a buffering agent, an UV-absorber and an antioxidant. A further antimicrobial compound may be an antifungal compound (e.g. imazalil) or a compound to combat insects, nematodes, mites and/or bacteria. Of course, the compositions according to the invention may also comprise two or more of any of the above additional compounds. Any of the above mentioned additional compounds may also be combined with the polyene antifungal compound and/or the lactoperoxidase system in case the antifungal compound and the lactoperoxidase system are applied separately. In an embodiment the additional compounds are additives acceptable for the specific use, e.g. food, feed, medicine, cosmetics or agriculture. Additional compounds suitable for use in food, feed, medicine, cosmetics or agriculture are known to the person skilled in the art.

In a specific embodiment the further antimicrobial compound is a natural crop protection compound belonging to the group of phosphites, e.g. KH₂PO₃ or K₂HPO₃ or a mixture of both phosphite salts. Phosphite containing compounds as used herein means compounds comprising a phosphite group, i.e. PO₃ (in the form of e.g. H₂PO₃⁻, HPO₃²⁻ or PO₃³⁻) or any compound which allows the release of a phosphite ion including compounds such as phosphorous acid and phosphonic acid as well as derivatives thereof such as esters and/or alkali metal or alkaline earth metal salts thereof. In case the compositions of the present invention comprise a polyene antifungal compound (e.g. natamycin) and at least one phosphite containing compound, they preferably comprise 0.1 g or less lignosulphonate, more preferably 0.1 g or less polyphenol, per gram polyene antifungal compound. Preferably, they comprise 0.01 g or less lignosulphonate, more preferably 0.01 g or less polyphenol, per gram polyene antifungal compound. In particular, they are free of lignosulphonate and preferably free of polyphenol. Suitable examples of phosphite containing compounds are phosphorous acid and its (alkali metal or alkaline earth metal) salts such as potassium phosphites e.g. KH₂PO₃ and K₂HPO₃, sodium phosphites and ammonium phosphites, and (C₁-C₄) alkyl esters of phosphorous acid and their salts such as aluminum ethyl phosphite (fosetyl-Al), calcium ethyl phosphite, magnesium isopropyl phosphite, magnesium isobutyl phosphite, magnesium sec-butyl phosphite and aluminum N-butyl phosphite. Of course, mixtures of phosphite containing compounds are also encompassed. A mixture of e.g. KH₂PO₃ and K₂HPO₃ can easily be obtained by e.g. adding KOH or K₂CO₃ to a final pH of 5.0-6.0 to a KH₂PO₃ solution. As indicated above, precursor-type compounds which in the crop or plant are metabolized into phosphite compounds can also be included in the compositions of the present invention. Examples are phosphonates such as the fosetyl-aluminium complex. In e.g. a crop or plant the ethyl phosphonate part of this molecule is metabolized into a phosphite. An example of such a compound in the commercial ethyl hydrogen phosphonate product called Aliette® (Bayer, Germany). The ratio of phosphite to natamycin (in weight) in the compositions is in general between 2:1 to 500:1 (w/w), preferably between 3:1 to 300:1 (w/w) and more preferably between 5:1 to 200:1 (w/w).

Compositions according to the invention may have a pH of from 1 to 10, preferably of from 2 to 9, more preferably of from 3 to 8 and most preferably of from 4 to 7. They may be solid, e.g. powder compositions, or may be liquid. The compositions of the present invention can be aqueous or non-aqueous ready-to-use compositions, but may also be aqueous or non-aqueous concentrated compositions/suspensions or stock compositions, suspensions and/or solutions which before use have to be diluted with a suitable diluent such as water or a buffer system. Alternatively, the compositions of the invention can also be used to prepare coating emulsions. The compositions of the present invention can also have the form of concentrated dry products such as e.g. powders, granulates and tablets. They can be used to prepare compositions for immersion or spraying of products such as agricultural products including plants, crops, vegetables and/or fruits. Of course, the above is also applicable when the polyene antifungal compound and the lactoperoxidase system are applied as separate compositions. In a further aspect the invention relates to a kit comprising a polyene antifungal compound and a lactoperoxidase system. The polyene antifungal compound and the lactoperoxidase system may be present in at least two separate packages, e.g. containers. Preferably, the kit comprises a form wherein the activity of the lactoperoxidase is delayed as long as possible, because this increases the shelf-life of the product. The activity of the lactoperoxidase starts as soon as hydrogen peroxide or a hydrogen peroxide donor is present. It is therefore recommended to supply the hydrogen peroxide or hydroxide peroxide generator system separate from the lactoperoxidase. In addition, the oil, emulsifier and the spreading agent can, if desired, also be packaged separately. In a specific embodiment, the invention thus pertains to a kit comprising a container comprising natamycin (and optionally additives), a container comprising lactoperoxidase (and optionally additives), a container comprising hydrogen peroxide and/or a hydrogen peroxide donor system (e.g. glucose oxidase, glucose and and optionally additives), a container comprising thiocyanate and/or a halide (such as iodide) (and optionally additives). The thiocyanate and halide (such as iodide) may be present in two separate containers if desired. Preferably, the thiocyanate and/or a halide (such as iodide) may be present in the container comprising the lactoperoxidase. In addition, the kit may comprise a container comprising an oil, an emulsifier and/or a spreading agent (and optionally additives). The components of the kit may be either in dry form or liquid form in the containers. If necessary, the kit may comprise instructions for dissolving the compounds. In addition, the kit may contain instructions for applying the compounds. The kit of the present invention generally comprises from about 0.005 g/l to about 500 g/l of each individual constituent. When a constituent is present in solid form (e.g. as a powder) in the kit, it may be present from 1-100%.

In a further aspect the invention pertains to a method for protecting a product against fungi by treating the product with a polyene antifungal compound and a lactoperoxidase system. In addition, the product can be treated with other antifungal and/or antimicrobial compounds either prior to, concomitant with or after treatment of the products with the polyene antifungal compound and the lactoperoxidase system. The product may be treated by sequential application of the polyene antifungal compound and the lactoperoxidase system or vice versa. Alternatively, the product may be treated by simultaneous application of the polyene antifungal compound and the lactoperoxidase system. In case of simultaneous application, the polyene antifungal compound and the lactoperoxidase system can be present in different compositions that are applied simultaneously or the polyene antifungal compound and the lactoperoxidase system may be present in a single composition. In yet another embodiment the product may be treated by separate or alternate modes of applying the polyene antifungal compound and the lactoperoxidase system. In an embodiment the invention is directed to a process for the treatment of products by applying the polyene antifungal compound and the lactoperoxidase system to the products. By applying the polyene antifungal compound and the lactoperoxidase system fungal growth on or in the products can be prevented. In other words, the polyene antifungal compound and the lactoperoxidase system protect the products from fungal growth and/or from fungal infection and/or from fungal spoilage. The polyene antifungal compound and the lactoperoxidase system can also be used to treat products that have been infected with a fungus. By applying the polyene antifungal compound and the lactoperoxidase system the disease development due to fungi on or in these products can be slowed down, stopped or the products may even be cured from the disease. In an embodiment of the invention the products are treated with a composition or kit according to the invention. In an embodiment the product is a food, feed, pharmaceutical, cosmetic or agricultural product. In a preferred embodiment the product is an agricultural product.

The polyene antifungal compound and the lactoperoxidase system, the compositions according to the invention and the kits according to the invention can be applied to the products by spraying. Other methods suitable for applying the polyene antifungal compound and the lactoperoxidase system, the compositions and the kits in liquid form to the products are also a part of the present invention. These include, but are not limited to, dipping, watering, drenching, introduction into a dump tank, vaporizing, atomizing, fogging, fumigating, painting, brushing, misting, dusting, foaming, spreading-on, packaging and coating (e.g. by means of wax or electrostatically). In addition, the polyene antifungal compound and the lactoperoxidase system may also be injected into the soil. Spraying applications using automatic systems are known to reduce the labour costs and are cost-effective. Methods and equipment well-known to a person skilled in the art can be used for that purpose. The polyene antifungal compound and the lactoperoxidase system can be regularly sprayed, when the risk of infection is high. When the risk of infection is lower spray intervals may be longer. Depending on the type of application, the amount of polyene antifungal compound applied may vary from 5 ppm to 10,000 ppm, preferably from 10 ppm to 5,000 ppm and most preferably from 20 to 1,000 ppm. The polyene antifungal compound and the lactoperoxidase system can be used to treat fungal diseases caused for example by the following fungi: Blumeria spp., e.g. Blumeria graminis; Uncinula spp., e.g. Uncinula necator; Leveillula spp., e.g. Leveillula taurica; Podosphaera spp., e.g. Podosphaera leucotricha, Podosphaera fusca, Podosphaera aphanis, Podosphaera xanthii; Microsphaera spp., e.g. Microsphaera syringae; Sawadaea spp., e.g. Sawadaea tulasnei; Mycosphaerella spp., e.g. Mycosphaerella musae, Mycosphaerella fragariae, Mycosphaerella citri; Mucor spp., e.g. Mucor piriformis; Monilinia spp., e.g. Monilinia fructigena, Monilinia laxa; Oidium spp., e.g. Oidium neolycopersici; Phomopsis spp., e.g. Phomopsis natalensis; Colletotrichum spp., e.g. Colletotrichum musae, Colletotrichum gloeosporioides, Colletotrichum coccodes; Verticillium spp., e.g. Verticillium theobromae; Nigrospora spp.; Botrytis spp., e.g. Botrytis cinerea; Diplodia spp., e.g. Diplodia citri; Pezicula spp.; Alternaria spp., e.g. Alternaria citri, Alternaria alternata; Septoria spp., e.g. Septoria depressa; Venturia spp., e.g. Venturia inaequalis, Venturia pyrina; Rhizopus spp., e.g. Rhizopus stolonifer, Rhizopus oryzae; Glomerella spp., e.g. Glomerella cingulata; Sclerotinia spp., e.g. Sclerotinia fruiticola; Ceratocystis spp., e.g. Ceratocystis paradoxa; Fusarium spp., e.g. Fusarium semitectum, Fusarium moniliforme, Fusarium solani, Fusarium oxysporum; Cladosporium spp., e.g. Cladosporium fulvum, Cladosporium cladosporioides, Cladosporium cucumerinum, Cladosporium musae; Penicillium spp., e.g. Penicillium funiculosum, Penicillium expansum, Penicillium digitatum, Penicillium italicum; Phytophthora spp., e.g. Phytophthora citrophthora, Phytophthora fragariae, Phytophthora cactorum, Phytophthora parasitica; Phacydiopycnis spp., e.g. Phacydiopycnis malirum; Plasmapara spp., e.g. Plasmopara viticola; Peronospora spp., e.g. Peronospora parasitica; Sclerospora spp., e.g. Sclerospora graminicola, Sclerospora mischanthi; Puccunia spp.; Venturia spp., Venturia inaequalis; Gloeosporium spp., e.g. Gloeosporium album, Gloeosporium perennans, Gloeosporium fructigenum, Gloeosporium singulata; Geotrichum spp., e.g. Geotrichum candidum; Phlyctaena spp., e.g. Phlyctaena vagabunda; Cylindrocarpon spp., e.g. Cylindrocarpon mali; Stemphyllium spp., e.g. Stemphyllium vesicarium; Thielaviopsis spp., e.g. Thielaviopsis paradoxy; Aspergillus spp., e.g. Aspergillus niger, Aspergillus carbonarius; Nectria spp., e.g. Nectria galligena; Cercospora spp., e.g. Cercospora angreci, Cercospora apii, Cercospora atrofiliformis, Cercospora musae, Cercospora zeae-maydis.

Another aspect of the present invention relates to the use of a polyene antifungal compound and a lactoperoxidase system to protect a product against fungi. As indicated above, the polyene antifungal compound and the lactoperoxidase system may be used, e.g. applied, sequentially or simultaneously. In an embodiment the invention relates to a use, wherein a composition or kit according to the invention is applied to the product. In an embodiment the product is a food, feed, pharmaceutical, cosmetic or agricultural product. In a preferred embodiment the product is an agricultural product such as a plant.

In a specific embodiment the polyene antifungal compound and the lactoperoxidase system can be used in medicine, e.g. to treat and/or prevent fungal diseases. The polyene antifungal compound and the lactoperoxidase system can for instance be used in the form of a pharmaceutical composition. The composition may further comprise pharmaceutically acceptable excipients. The polyene antifungal compound and the lactoperoxidase system may be administered orally or parenterally. The type of composition is dependent on the route of administration.

A further aspect of the invention is directed to a product treated with a polyene antifungal compound and a lactoperoxidase system. In an embodiment the product is treated with a composition or kit according to the invention. The invention is therefore directed to a product comprising a polyene antifungal compound and a lactoperoxidase. The treated products may comprise a polyene antifungal compound and a lactoperoxidase on their surface and/or inside the product. Alternatively, the treated products may comprise a coating comprising a polyene antifungal compound and a lactoperoxidase. In an embodiment the treated products comprise from 0.000001 to 200 mg/dm², preferably 0.00001 to 100 mg/dm², more preferably from 0.00005 to 10 mg/dm² of the polyene antifungal compound on their surface. In a further embodiment they comprise from 0.000001 to 200 mg/dm², preferably 0.00001 to 100 mg/dm², more preferably from 0.00005 to 10 mg/dm² of the lactoperoxidase on their surface. In an embodiment the product may also comprise at least one other component of the lactoperoxidase system. The product may comprise, next to the polyene antifungal compound and the lactoperoxidase, a thiocyanate or salt thereof, and/or a halide or salt thereof, and/or hydrogen peroxide and/or components of a hydrogen peroxide donor system such as glucose, glucose oxidase and percarbonate. In addition, the products may comprise an oil and/or emulsifier and/or spreading agent present in the lactoperoxidase system. Furthermore, the products may comprise any of the oxidation products generated by the lactoperoxidase system. In an embodiment the product is a food, feed, pharmaceutical, cosmetic or agricultural product. In a preferred embodiment the product is an agricultural product such as a plant.

The term “food products” as used herein is to be understood in a very broad sense and includes, but is not limited to, cheese, cream cheese, shredded cheese, cottage cheese processed cheese, sour cream, dried fermented meat product including salamis and other sausages, wine, beer, yoghurt, juice and other beverages, salad dressing, cottage cheese dressing, dips, bakery products and bakery fillings, surface glazes and icing, spreads, pizza toppings, confectionery and confectionery fillings, olives, olive brine, olive oil, juices, tomato purees and paste, condiments, and fruit pulp and the like food products.

The term “feed products” as used herein is also to be understood in a very broad sense and includes, but is not limited to, pet food, broiler feed, etc.

The term “pharmaceutical product” as used herein is also to be understood in a very broad sense and includes products comprising an active molecule such as a drug, agent, or pharmaceutical compound and optionally a pharmaceutically acceptable excipient, i.e. any inert substance that is combined with the active molecule for preparing an agreeable or convenient dosage form.

The term “cosmetic product” as used herein is also to be understood in a very broad sense and includes products that are used for protecting or treating horny tissues such as skin and lips, hair and nails from drying by preventing transpiration of moisture thereof and further conditioning the tissues as well as giving good appearance to these tissues. Products contemplated by the term “cosmetic product” include, but are not limited to, moisturizers, personal cleansing products, occlusive drug delivery patches, nail polish, powders, wipes, hair conditioners, skin treatment emulsions, shaving creams and the like.

The term “agricultural products” as used herein is also to be understood in a very broad sense and includes, but is not limited to, cereals, e.g. wheat, barley, rye, oats, rice, sorghum and the like; beets, e.g. sugar beet and fodder beet; pome and stone fruit and berries, e.g. apples, pears, plums, apricots, peaches, almonds, cherries, strawberries, raspberries and blackberries; leguminous plants, e.g. beans, lentils, peas, soy beans; oleaginous plants, e.g. rape, mustard, poppy, olive, sunflower, coconut, castor-oil plant, cocoa, ground-nuts; cucurbitaceae, e.g. pumpkins, gherkins, melons, cucumbers, squashes, aubergines; fibrous plants, e.g. cotton, flax, hemp, jute; citrus fruit, e.g. oranges, lemons, grapefruits, mandarins, limes; tropical fruit, e.g. papayas, passion fruit, mangos, carambolas, pineapples, bananas, kiwis; vegetables, e.g.

spinach, lettuce, asparagus, brassicaceae such as cabbages and turnips, carrots, onions, tomatoes, potatoes, seed-potatoes, hot and sweet peppers; laurel-like plants, e.g. avocado, cinnamon, camphor tree; or products such as maize, tobacco, nuts such as pistachio nuts, peanuts and cashew nuts, coffee beans, sugarcane, tea, grapevines, hops, rubber plants, as well as ornamental plants, e.g. cut flowers, roses, tulips, lilies, narcissus, crocuses, hyacinths, dahlias, gerbera, carnations, fuchsias, chrysanthemums, and flower bulbs, shrubs, deciduous trees and evergreen trees such as conifers, plants and trees in greenhouses. It includes, but is not limited to, plants and their parts, fruits, seeds, cuttings, cultivars, grafts, bulbs, tubers, root-tubers, rootstocks, cut flowers and vegetables.

A method for preparing a composition as described herein is another aspect of the present invention. The method comprises adding a polyene antifungal compound to a lactoperoxidase system or at least to one of the components of the lactoperoxidase system. The polyene antifungal compound and the components of the lactoperoxidase system may for instance be added separately to an aqueous composition and mixed, followed, if necessary, by adjustment of the pH, viscosity, etc. If added separately, some or all of the separate components may be in powder form, but alternatively some or all may also be in liquid form. The polyene antifungal compound and the components of the lactoperoxidase system may for instance also be added to one another in powder form and mixed to obtain a powdered composition. The powdered composition may then be added to an aqueous composition.

### EXAMPLES

### Example 1

### Treatment of Tomato Plants Against Mildew Disease

Tomato plants were grown in a greenhouse using well known methods. Twenty-five days after planting, the tomato plants were inoculated with powdery mildew spores (spores of Oidium neolycopersici).

Fourteen days after the tomato plants were inoculated with the spores, the plants were treated with:

a) a composition comprising natamycin (1500 ppm),

b) a composition comprising a lactoperoxidase system, or

c) a composition comprising natamycin (1500 ppm) and a lactoperoxidase system (natamycin and the lactoperoxidase system were mixed before application to the tomato plants).

As a control, untreated tomato plants were used.

All compositions comprising natamycin comprised glycerol (2.5 ml/l ) and polyether trisiloxane (BREAK-TRU®; 0.25 ml/l ). The lactoperoxidase system comprised lactoperoxidase, potassium iodide, potassium thiocyanate and a hydrogen peroxide source. When the lactoperoxidase system was used alone, ADDIT, a rapeseed-oil based adjuvant, was added to the lactoperoxidase system.

The tomato plants were sprayed with 2000 lof the respective composition per ha, corresponding to a rate of about 130 ml of the respective composition per plant. The trial was performed on four plots with each plot containing 5 tomato plants.

Powdery mildew growth was assessed in a twofold manner: (i) the number of visible colonies on 2 marked leafs of each tomato plant were counted; and (ii) the antifungal activity (in %) of the individual and combined active ingredients was determined by calculating the reduction in mould growth observed on the marked leafs of the tomato plants that were treated with the antifungal composition in comparison to the mould growth on the marked leafs of the tomato plants that were treated with the control composition. The expected antifungal activity (E in %) of the combined antifungal composition comprising both active ingredients was calculated according to the Colby equation (Colby, 1967):

E=X+Y−[(X·Y)/100]

wherein X and Y are the observed antifungal activities (in %) of the individual active ingredients X and Y, respectively. If the observed antifungal activity (O in %) of the combination exceeds the expected antifungal activity (E in %) of the combination and the synergy factor O/E is thus >1.0, the combined application of the active ingredients leads to a synergistic antifungal effect.

The results in Table 1 (the number of visible colonies on 2 marked leafs of each tomato plant) clearly demonstrate that the antifungal composition comprising both natamycin and the lactoperoxidase system had a much stronger antifungal effect on tomato plants than natamycin or the lactoperoxidase system alone.

Tomato plants treated with either nothing (control), natamycin alone or the lactoperoxidase system alone showed an increase in visible fungal colonies at 9 days after application of the respective compositions. When natamycin was used in combination with the lactoperoxidase system however, a decrease in visible fungal colonies at 9 days after application of the composition was observed.

Furthermore, the synergy factor O/E as calculated according to the Colby equation exceeded 1, meaning that the combined application of natamycin and the lactoperoxidase system leads to a synergistic antifungal effect.

TABLE 1
Average number of fungal colonies per tomato leaf.

| | | | Day 9 corrected |
|---|---|---|---|
| Composition | Day −1* | Day 9 | for Day −1** |
| Control | 6.9 | 47.0 | 40.1 |
| Natamcyin | 6.1 | 11.9 | 5.8 |
| Lactoperoxidase system | 5.3 | 9.3 | 4.0 |
| Natamcyin + lactoperoxidase system | 6.1 | 5.3 | −0.8 |

* Day −1 = one day before application of the composition
** A positive number indicates that the average number of visible fungal colonies increases from day −1 to day 9, while a negative number indicates that the average number of visible fungal colonies decreases from day −1 to day 9.

In conclusion, the results clearly demonstrate that the composition comprising natamycin and the lactoperoxidase system protect tomato plants from powdery mildew growth and further show that the composition of the present invention show a synergistically enhanced activity compared to the activity of the active compounds when applied individually.

### Example 2

### Treatment of Tomato Plants Against Mildew Disease

The experiment was done as described in Example 1, with the proviso that first of all the lactoperoxidase system was applied to the tomato plants and after one hour (when the tomato plants were dry again) the natamycin composition was applied. The results are shown in Table 2

TABLE 2
Average number of fungal colonies per tomato leaf.

| | | | Day 9 corrected |
|---|---|---|---|
| Composition | Day −1* | Day 9 | for Day −1** |
| Control | 6.9 | 47.0 | 40.1 |
| Natamcyin | 6.1 | 11.9 | 5.8 |
| Lactoperoxidase system | 5.3 | 9.3 | 4.0 |
| Natamcyin + lactoperoxidase system | 8.9 | 4.1 | −4.8 |

*Day −1 = one day before application of the composition
**A positive number indicates that the average number of visible fungal colonies increases from day −1 to day 9, while a negative number indicates that the average number of visible fungal colonies decreases from day −1 to day 9.

Tomato plants treated with either nothing (control), natamycin alone or the lactoperoxidase system alone showed an increase in visible fungal colonies at 9 days after application of the respective compositions. When natamycin was used in combination with the lactoperoxidase system however, a decrease in visible fungal colonies at 9 days after application of the composition was observed.

Furthermore, the synergy factor O/E as calculated according to the Colby equation exceeded 1, meaning that the combined application of natamycin and the lactoperoxidase system leads to a synergistic antifungal effect.

The results clearly demonstrate that applying a combination of natamycin and the lactoperoxidase system protect tomato plants from powdery mildew growth and further show that application of a lactoperoxidase system followed by application of natamycin shows a synergistically enhanced activity compared to the activity of the active compounds when applied individually.

### REFERENCES

Brent K J and Hollomon D W (2007), Fungicide resistance in crop pathogens: How can it be managed? Second revised edition. Published by the Fungicide Resistance Action Committee. FRAC Monograph No. 1, pages 1-60.
Colby SR (1967), Calculating synergistic and antagonistic responses of herbicide combination. Weeds 15: 20-22.

1. A composition comprising:
a) a polyene antifungal compound, and
b) a lactoperoxidase system.

2. A composition according to claim 1, wherein the lactoperoxidase system comprises:
a) a lactoperoxidase,
b) a thiocyanate, a halide or both, and
c) hydrogen peroxide and/or a hydrogen peroxide donor system.

3. A composition according to claim 1, wherein the polyene antifungal compound is natamycin.

4. A composition according to claim 1, wherein the composition further comprises at least one additional compound selected from the group consisting of a sticking agent, a carrier, a colouring agent, a protective colloid, an adhesive, a fertilizer, a thickening agent, a sequestering agent, a thixotropic agent, a surfactant, a further antimicrobial compound, a detergent, a preservative, a spreading agent, a filler, a spray oil, a flow additive, a mineral substance, a solvent, a dispersant, an emulsifier, a wetting agent, a stabiliser, an antifoaming agent, a buffering agent, an UV-absorber and an antioxidant.

5. A composition according to claim 1, wherein the amount of the polyene antifungal compound is in a range from 0.005 g/l to about 100 g/l.

6. A kit comprising a polyene antifungal compound and a lactoperoxidase system.

7. A method for protecting a product against fungi by treating the product with a polyene antifungal compound and a lactoperoxidase system.

8. A method for protecting a product against fungi, wherein the product is treated with a composition according to claim 1.

9. A method according to claim 7, wherein the product is selected from the group consisting of a food product, a feed product, a pharmaceutical product, a cosmetic product and an agricultural product.

10. A product comprising a polyene antifungal compound and a lactoperoxidase.

11. A product according to claim 10 further comprising:
a) a thiocyanate or salt thereof, and/or
b) a halide or salt thereof, and/or
c) hydrogen peroxide and/or a hydrogen peroxide donor system.

12. A product according to claim 10, wherein the hydrogen peroxide donor system comprises glucose, glucose oxidase and percarbonate.

13. A product according to claim 10, wherein the product is selected from the group consisting of a food product, a feed product, a pharmaceutical product, a cosmetic product and an agricultural product.

14. A product according to claim 10, wherein the product is a plant.

15. A polyene antifungal compound and a lactoperoxidase system capable of being used to protect a product against fungi.
